(19) United States
(12) Patent Application Publication
(10) Pub. No.: US 2025/0004092 A1
(43) Pub. Date: Jan. 2, 2025

(54) ESTABLISHING COOPERATIVE RADAR SENSING SESSIONS

(71) Applicant: QUALCOMM Incorporated, San Diego, CA (US)

(72) Inventors: Mahmoud ASHOUR, San Diego, CA (US); Stelios STEFANATOS, San Diego, CA (US); Kapil GULATI, Belle Mead, NJ (US); Preeti KUMARI, San Diego, CA (US); Anantharaman BALASUBRAMANIAN, San Diego, CA (US); Junyi LI, Greentown, PA (US)

(21) Appl. No.: 18/709,607

(22) PCT Filed: Dec. 21, 2022
(86) PCT No.: PCT/US2022/082132

§ 371 Date: May 13, 2024

(30) Foreign Application Priority Data
Jan. 7, 2022 (GR) 20220100010

(51) Int. Cl. G01S 7/00; G01S 13/00; G01S 13/87; G01S 13/931; H04W 64/00; H04W 76/14

(52) U.S. Cl. CPC G01S 7/003; G01S 13/87; H04W 64/006; H04W 76/14; G01S 13/003; G01S 13/931; G01S 2013/9316

(57) ABSTRACT

Various aspects of the present disclosure generally relate to wireless communication. In some aspects, a first user equipment (UE) may transmit a discovery message to discover another UE with which to establish a cooperative radar sensing session. The first UE may receive, from a second UE, a join request for the first UE to establish the cooperative radar sensing session with the second CE, The first UE may transmit, to the second UE, an acceptance indication based at least in part on the join request. The first UE may communicate with the second UE to establish a joint configuration to be used by the first UE and the second UE for the cooperative radar sensing session, Numerous other aspects are described.

### CROSS-REFERENCE TO RELATED APPLICATION

This patent application claims priority to Greece Patent Application No. 20220100010, filed on Jan. 7, 2022, entitled “ESTABLISHING COOPERATIVE RADAR SENSING SESSIONS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for establishing cooperative radar sensing sessions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a first user equipment (UE) for wireless communication. The first user equipment may include a memory and one or more processors coupled to the memory. The one or more processors may be configured to transmit a discovery message to discover another UE with which to establish a cooperative radar sensing session. The one or more processors may be configured to receive, from a second UE, a join request for the first UE to establish the cooperative radar sensing session with the second UE. The one or more processors may be configured to transmit, to the second UE, an acceptance indication based at least in part on the join request. The one or more processors may be configured to communicate with the second UE to establish a joint configuration to be used by the first UE and the second UE for the cooperative radar sensing session.

Some aspects described herein relate to a second UE for wireless communication. The second user equipment may include a memory and one or more processors coupled to the memory. The one or more processors may be configured to receive, from a first UE, a discovery message relating to establishing a cooperative radar sensing session. The one or more processors may be configured to transmit, to the first UE, a join request for the first UE to establish the cooperative radar sensing session with the second UE. The one or more processors may be configured to receive, from the first UE, an acceptance indication based at least in part on the join request. The one or more processors may be configured to communicate with the first UE to establish a joint configuration to be used by the first UE and the second UE for the cooperative radar sensing session.

Some aspects described herein relate to a method of wireless communication performed by a first UE. The method may include transmitting a discovery message to discover another UE with which to establish a cooperative radar sensing session. The method may include receiving, from a second UE, a join request for the first UE to establish the cooperative radar sensing session with the second UE. The method may include transmitting, to the second UE, an acceptance indication based at least in part on the join request. The method may include communicating with the second UE to establish a joint configuration to be used by the first UE and the second UE for the cooperative radar sensing session.

Some aspects described herein relate to a method of wireless communication performed by a second UE. The method may include receiving, from a first UE, a discovery message relating to establishing a cooperative radar sensing session. The method may include transmitting, to the first UE, a join request for the first UE to establish the cooperative radar sensing session with the second UE. The method may include receiving, from the first UE, an acceptance indication based at least in part on the join request. The method may include communicating with the first UE to establish a joint configuration to be used by the first UE and the second UE for the cooperative radar sensing session.

Some aspects described herein relate to a non-transitory computer-readable medium that stores a set of instructions for wireless communication by a first UE. The set of instructions, when executed by one or more processors of the first UE, may cause the first UE to transmit a discovery message to discover another UE with which to establish a cooperative radar sensing session. The set of instructions, when executed by one or more processors of the first UE, may cause the first UE to receive, from a second UE, a join request for the first UE to establish the cooperative radar sensing session with the second UE. The set of instructions, when executed by one or more processors of the first UE, may cause the first UE to transmit, to the second UE, an acceptance indication based at least in part on the join request. The set of instructions, when executed by one or more processors of the first UE, may cause the first UE to communicate with the second UE to establish a joint configuration to be used by the first UE and the second UE for the cooperative radar sensing session.

Some aspects described herein relate to a non-transitory computer-readable medium that stores a set of instructions for wireless communication by a second UE. The set of instructions, when executed by one or more processors of the second UE, may cause the second UE to receive, from a first UE, a discovery message relating to establishing a cooperative radar sensing session. The set of instructions, when executed by one or more processors of the second UE, may cause the second UE to transmit, to the first UE, a join request for the first UE to establish the cooperative radar sensing session with the second UE. The set of instructions, when executed by one or more processors of the second UE, may cause the second UE to receive, from the first UE, an acceptance indication based at least in part on the join request. The set of instructions, when executed by one or more processors of the second UE, may cause the second UE to communicate with the first UE to establish a joint configuration to be used by the first UE and the second UE for the cooperative radar sensing session.

Some aspects described herein relate to an apparatus for wireless communication. The apparatus may include means for transmitting a discovery message to discover a UE with which to establish a cooperative radar sensing session. The apparatus may include means for receiving, from the UE, a join request to establish the cooperative radar sensing session with the UE. The apparatus may include means for transmitting, to the UE, an acceptance indication based at least in part on the join request. The apparatus may include means for communicating with the UE to establish a joint configuration to be used for the cooperative radar sensing session.

Some aspects described herein relate to an apparatus for wireless communication. The apparatus may include means for receiving, from a UE, a discovery message relating to establishing a cooperative radar sensing session. The apparatus may include means for transmitting, to the UE, a join request for the UE to establish the cooperative radar sensing session with the apparatus. The apparatus may include means for receiving, from the UE, an acceptance indication based at least in part on the join request. The apparatus may include means for communicating with the UE to establish a joint configuration to be used for the cooperative radar sensing session.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of radar sensing, in accordance with the present disclosure.

FIGS. 6A-6B are diagrams illustrating an example associated with establishing cooperative radar sensing sessions, in accordance with the present disclosure.

FIGS. 7-8 are diagrams illustrating example processes associated with establishing cooperative radar sensing sessions, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

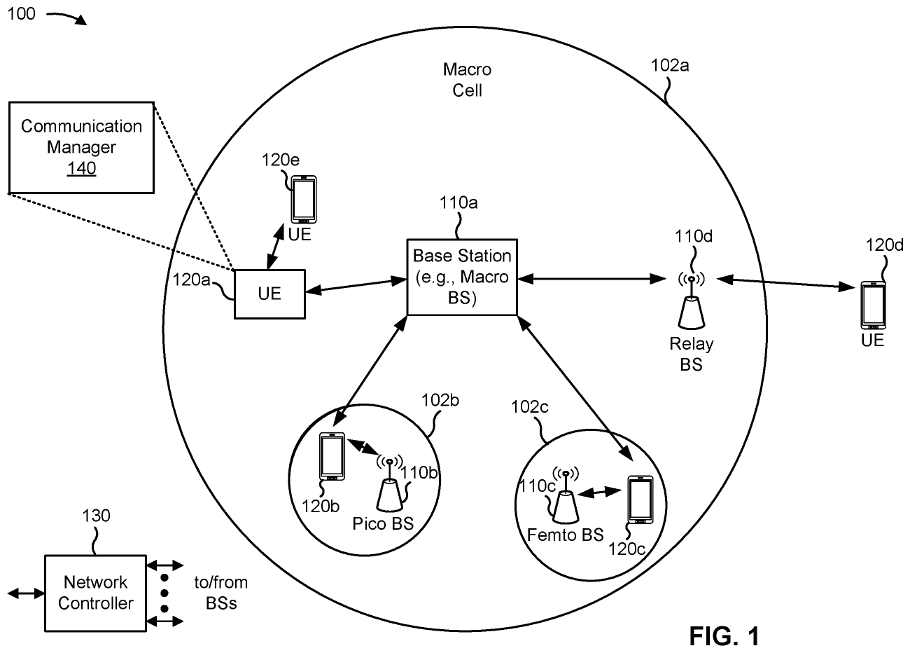

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit a discovery message to discover another UE with which to establish a cooperative radar sensing session; receive, from another UE, a join request for the first UE to establish the cooperative radar sensing session with the other UE; transmit, to the other UE, an acceptance indication based at least in part on the join request; and communicate with the other UE to establish a joint configuration to be used by the UE 120 and the other UE for the cooperative radar sensing session. Additionally, or alternatively, the communication manager 140 may perform one or more other operations described herein.

In some aspects, as described in more detail elsewhere herein, the communication manager 140, included in the UE 120, may receive, from another UE, a discovery message relating to establishing a cooperative radar sensing session; transmit, to the other UE, a join request for the other UE to establish the cooperative radar sensing session with the UE 120; receive, from the other UE, an acceptance indication based at least in part on the join request; and communicate with the other UE to establish a joint configuration to be used by the other UE and the UE 120 for the cooperative radar sensing session. Additionally, or alternatively, the communication manager 140 may perform one or more other operations described herein.

As indicated above, FIG. 1 is provided as an example. Other examples may differ from what is described with regard to FIG. 1.

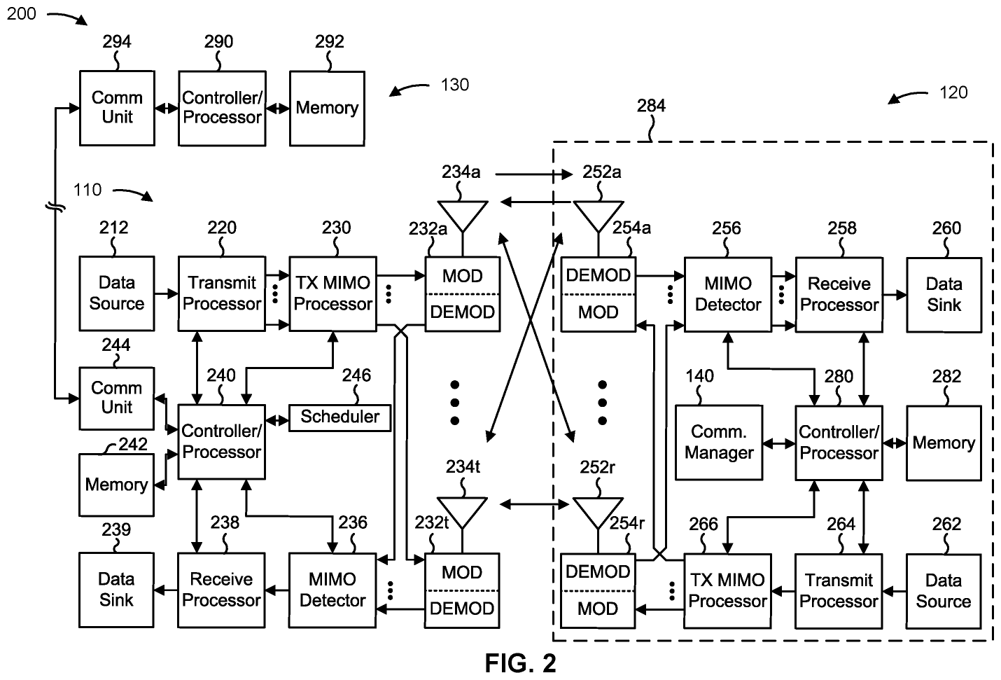

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

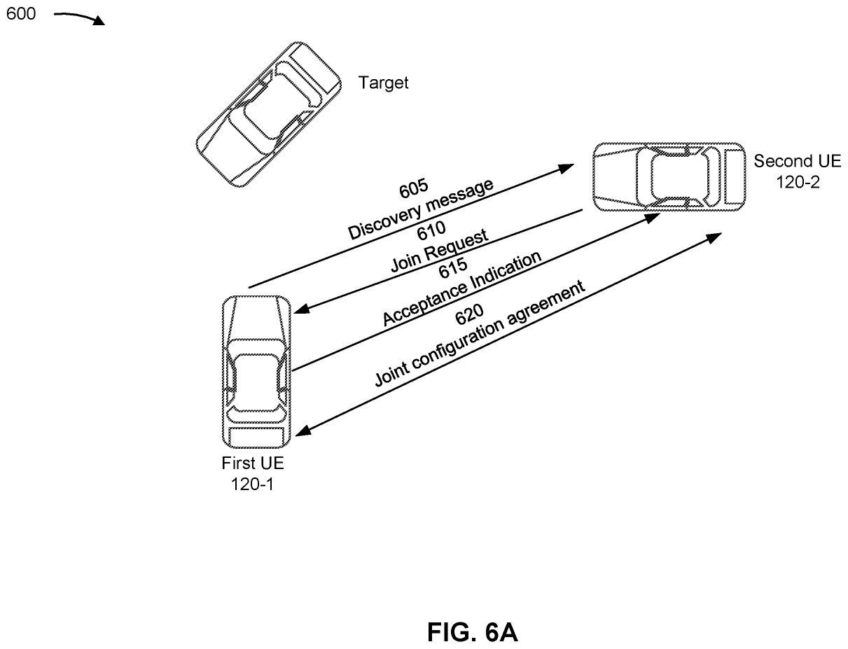

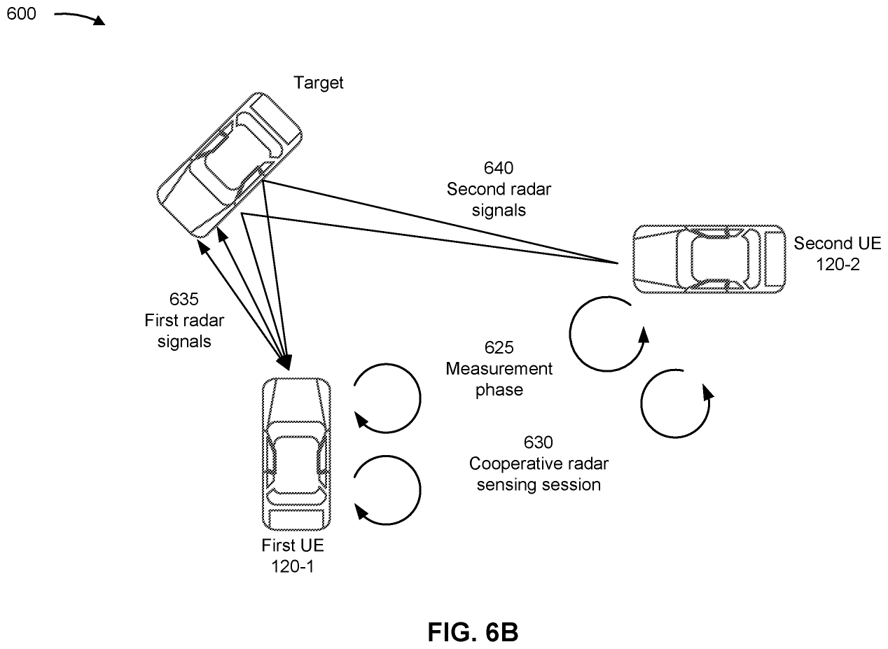

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6A, 6B, 7, 8, and 9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6A, 6B, 7, 8, and 9).

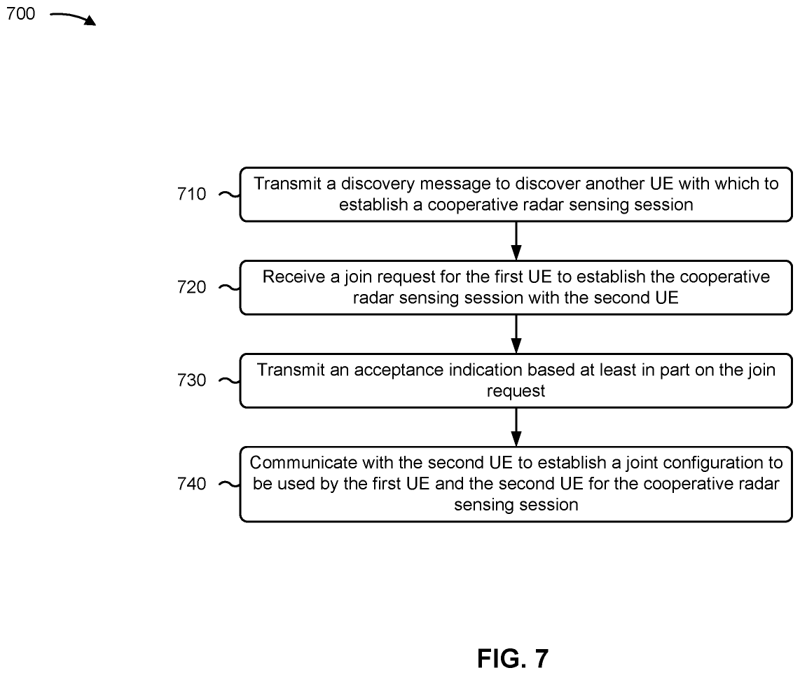

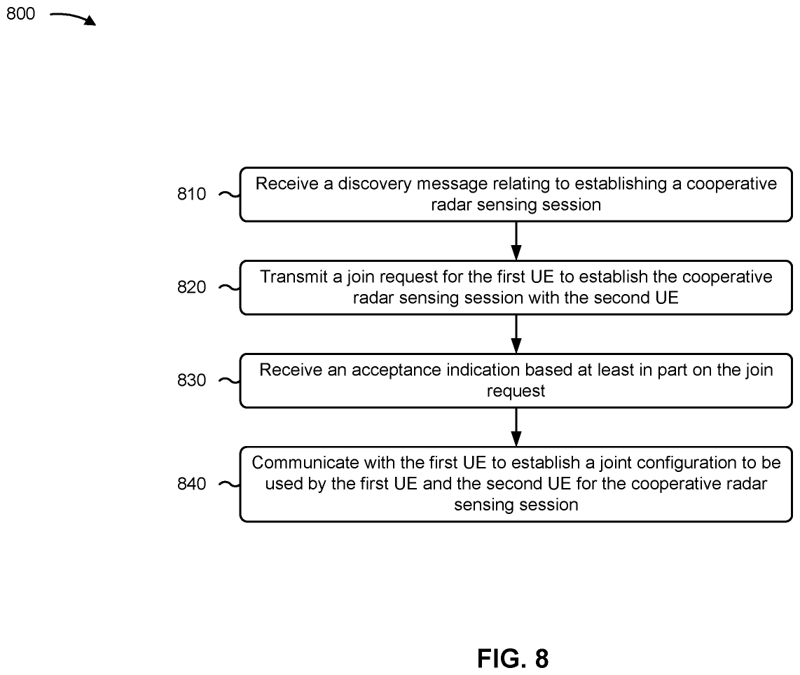

The controller/processor 240 of the base station 110, the controller/processor 280 of the UE 120, and/or any other component(s) of FIG. 2 may perform one or more techniques associated with establishing cooperative radar sensing sessions, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE includes means for transmitting a discovery message to discover another UE with which to establish a cooperative radar sensing session; means for receiving, from a second UE, a join request for the first UE to establish the cooperative radar sensing session with the second UE; means for transmitting, to the second UE, an acceptance indication based at least in part on the join request; and/or means for communicating with the second UE to establish a joint configuration to be used by the first UE and the second UE for the cooperative radar sensing session. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for receiving, from a first UE, a discovery message relating to establishing a cooperative radar sensing session; means for transmitting, to the first UE, a join request for the first UE to establish the cooperative radar sensing session with the second UE; means for receiving, from the first UE, an acceptance indication based at least in part on the join request; and/or means for communicating with the first UE to establish a joint configuration to be used by the first UE and the second UE for the cooperative radar sensing session. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

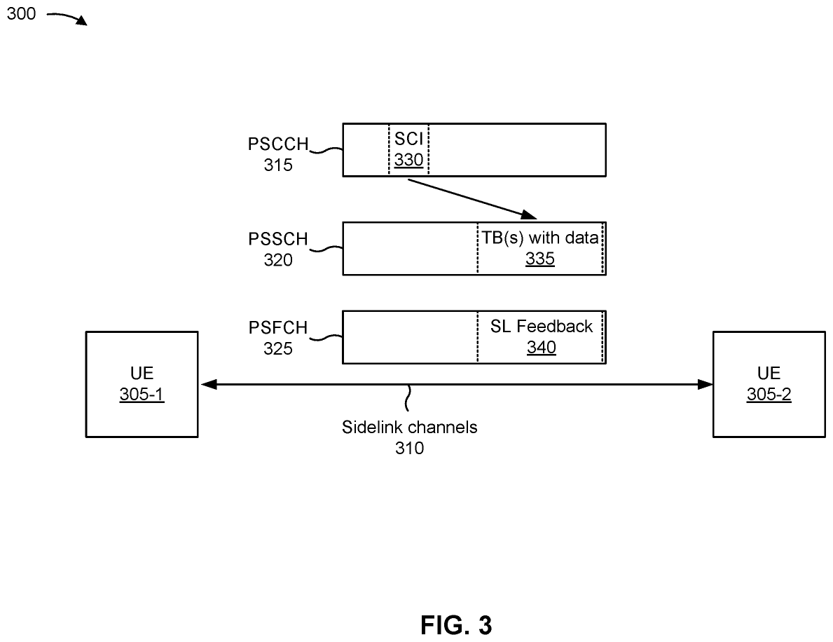

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some examples, the UEs 305 (e.g., UE 305-1 and/or UE 305-2) may correspond to one or more other UEs described elsewhere herein, such as UE 120. In some examples, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330 (e.g., first stage SCI (SCI-1)) which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information).

Although shown on the PSCCH 315 in FIG. 3, in some examples, the SCI 330 may include multiple communications in different stages. For example, SCI (SCI-1) may be transmitted on the PSCCH 315, and second stage SCI (SCI-2) may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process identifier (ID), a new data indicator (NDI), a source identifier, a destination identifier, and/or a channel state information (CSI) report trigger.

In some examples, the one or more sidelink channels 310 may use resource pools. For example, a scheduling assignment (e.g., included in SCI 330) may be transmitted in sub-channels using specific resource blocks (RBs) across time. In some examples, data transmissions (e.g., on the PSSCH 320) associated with a scheduling assignment (e.g., SCI-1) may occupy adjacent RBs in the same slot as the scheduling assignment (e.g., using frequency division multiplexing).

In some examples, a UE 305 may operate using a resource allocation mode (e.g., Mode 1) in which a base station allocates resources for sidelink communications between UEs 305. In some examples, a UE 305 may operate using a resource allocation mode (e.g., Mode 2) in which resource selection and/or scheduling is autonomously performed by the UE 305 (e.g., rather than a base station 110). In some examples, the UE 305 may perform resource selection and/or scheduling by sensing channel availability for transmissions using Mode 2. For example, the UE 305 may measure an RSSI parameter (e.g., a sidelink-RSSI (S-RSSI) parameter) associated with various sidelink channels, may measure an RSRP parameter (e.g., a PSSCH-RSRP and/or PSCCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 carried in the PSCCH 315 (e.g., SCI-1), which may indicate occupied resources and/or channel parameters. Additionally, or alternatively, the UE 305 may perform resource selection and/or scheduling by determining a channel busy rate (CBR) associated with various sidelink channels, which may be used for rate control (e.g., by indicating a maximum number of RBs that the UE 305 can use for a particular set of subframes).

In the resource allocation mode 2 where resource selection and/or scheduling is performed by a UE 305, the UE 305 may generate sidelink grants with reserved resources, and may transmit the grants in SCI 330. A sidelink grant may indicate, for example, one or more parameters (e.g., transmission parameters) to be used for an upcoming sidelink transmission, such as one or more subchannels to be used for the upcoming sidelink transmission on the PSSCH 320 (e.g., for TBs 335), one or more slots to be used for the upcoming sidelink transmissions, and/or an MCS to be used for the upcoming sidelink transmission. In some examples, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an aperiodic sidelink transmission.

As indicated above, FIG. 3 is provided as an example. Other examples may differ from what is described with respect to FIG. 3.

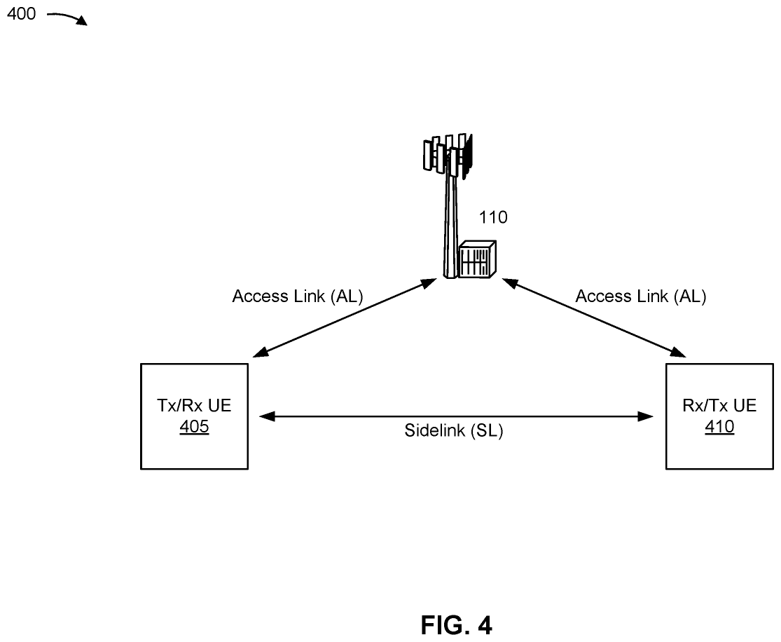

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink resource allocation modes, a base station 110 may communicate with the Tx/Rx UE 405 via a first access link. Additionally, or alternatively, in some sidelink resource allocation modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

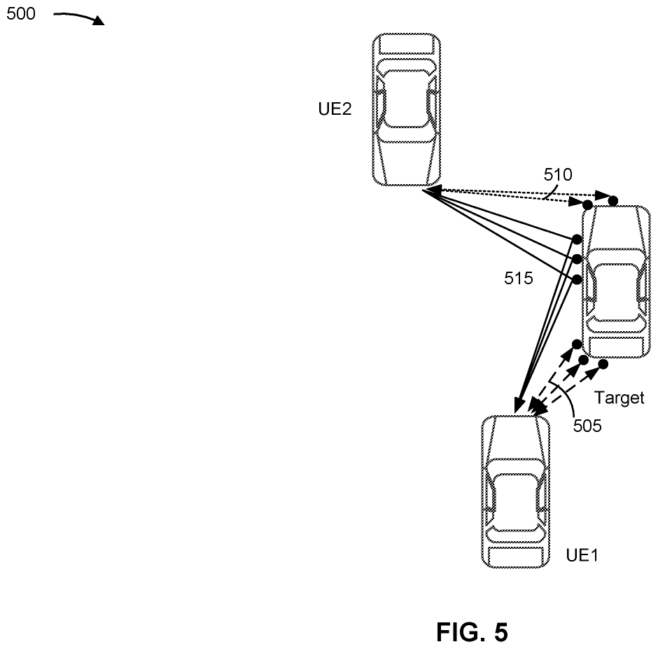

FIG. 5 is a diagram illustrating an example 500 of radar sensing, in accordance with the present disclosure.

As shown in FIG. 5, example 500 includes a first UE (UE1) and a second UE (UE2). In some aspects, UE1 may be associated with a first vehicle. For example, UE1 may be integrated into the first vehicle, may be located in or on the first vehicle, or may be the first vehicle. In some aspects, UE2 may be associated with a second vehicle. For example, UE2 may be integrated into the second vehicle, may be located in or on the second vehicle, or may be the second vehicle. The UEs may communicate using a V2X protocol (e.g., which may include a V2V protocol, a V2I protocol, a V2P protocol, and/or the like).

UE1 (and/or the first vehicle associated with UE1) may be equipped with a radar sensor for sensing an environment in a vicinity of UE1. The radar sensor may include a transmitter for transmitting radar signals and a receiver for receiving reflected radar signals. In some examples, UE1 may perform monostatic sensing using the radar sensor. “Monostatic sensing” refers to radar sensing in which the transmitter and the receiver are co-located. For example, UE1 may transmit radar signals 505 and receive reflections of the radar signals 505 that are reflected by a target object. UE1 may generate a point cloud representing a location and a shape of the target object based on the received reflections of the radar signals 505 transmitted by UE1. UE2 (and/or the second vehicle associated with UE2) may also be equipped with a radar sensor, and UE2 may also perform monostatic sensing using the radar sensor. For example, UE2 may transmit radar signals 510 and receive reflections of the radar signals 510 that are reflected by the target object. However, in some cases, when multiple radar-equipped UEs/vehicles are near each other, the radar sensing performed by a UE (e.g., UE1) may be adversely affected by interference from the radar sensing performed by a nearby UE (e.g., UE2).

In some aspects, when multiple radar equipped UEs/vehicles are located near each other, it may be beneficial for the UEs to perform cooperative radar sensing. Cooperative radar sensing may reduce or eliminate interference between nearby UEs, and may also improve the performance of the radar sensing performed by one or more of the UEs. “Cooperative radar sensing” may refer to radar sensing in which a UE/vehicle senses an environment based at least in part on information received from the monostatic returns (e.g., reflections) of the radar signals transmitted by the UE/vehicle and information received from bistatic returns (e.g., reflections) of radar signals transmitted by another (e.g., nearby) UE/vehicle. For example, as shown in FIG. 5, in a cooperative radar sensing session, UE1 may perform monostatic sensing of the radar signals 505 transmitted by UE1 and bistatic sensing of radar signals 515 transmitted by UE2. “Bistatic sensing” refers to radar sensing in which the transmitter and the receiver are spatially separated. As shown in FIG. 5, UE1 may receive reflections of the radar signals 505 transmitted by UE1, and the UE1 may receive reflections of the radar signals 515 transmitted by the UE2. By utilizing both the monostatic returns (e.g., the reflections of the radar signals 505) and the bistatic returns (e.g., the reflections of the radar signals 515), UE1 may sense a denser point cloud of the target object, as compared to a point cloud sensed only using the monostatic returns. However, cooperative radar sensing may require cooperation between UEs/vehicles. Currently, a UE/vehicle may not be able to discover whether there is another radar-equipped UE/vehicle nearby, and a UE/vehicle may not have a way to establish a cooperative radar sensing session with a nearby UE/vehicle. In addition, a UE/vehicle may not be able to process both monostatic returns and bistatic returns due to different radar parameters being used by a nearby UE/vehicle.

Some techniques and apparatuses described herein enable a first UE to transmit a discovery message to discover another UE with which to establish a cooperative radar sensing session. A second UE may receive the discovery message, and the second UE may transmit, to the first UE, a join request for the first UE to establish the cooperative radar sensing session with the second UE. The first UE may receive the join request, and the first UE may transmit, to the second UE, an acceptance indication based at least in part on the join request. The first UE and the second UE may communicate to establish a joint configuration to be used by the first UE and the second UE for the cooperative radar sensing session. As a result, a UE may be able to discover another UE with which to establish a cooperative radar sensing session, and the UE may be able to establish the cooperative radar sensing session with the other UE. In addition, the UEs may agree to a joint configuration for radar sensing, which may result in the UEs being able to process both monostatic and bistatic returns during the cooperative radar sensing session. This may allow the UEs to improve the performance of radar sensing, as compared to stand-alone radar sensing using monostatic returns, and reduce interference due to radar sensing by nearby UEs.

As indicated above, FIG. 5 is provided as an example. Other examples may differ from what is described with respect to FIG. 5.

FIGS. 6A-6B are diagrams illustrating an example 600 associated with establishing cooperative radar sensing sessions, in accordance with the present disclosure. As shown in FIG. 6, example 600 includes communication between a first UE 120-1 and a second UE 120-2. In some aspects, the first UE 120-1 and the second UE 120-2 may be included in a wireless network, such as wireless network 100. The first UE 120-1 and the second UE 120-2 may communicate via sidelink communications. In some aspects, the first UE 120-1 and the second UE 120-2 may communicate via V2X communications, such as cellular V2X (CV2X) communications.

In some aspects, the first UE 120-1 may be associated with a first vehicle. For example, the first UE 120-1 may be integrated into the first vehicle, may be located in or on the first vehicle, or may be the first vehicle. In some aspects, the second UE 120-2 may be associated with a second vehicle. For example, the second UE 120-2 may be integrated into the second vehicle, may be located in or on the second vehicle, or may be the second vehicle. In some aspects, the first UE 120-1 and the second UE 120-2 may be radar-equipped UEs. “Radar-equipped UE” may refer to a UE equipped with a radar sensor and/or a UE associated with a vehicle equipped with a radar sensor. Although the first UE 120-1 and the second UE 120-2 in FIGS. 6A and 6B are shown as being associated with respective vehicles, in some aspects, one or more of the second UE 120-2 and/or the second UE 120-2 may not be associated with a vehicle.

FIG. 6A shows a discovery phase, in which the first UE 120-1 discovers and establishes a radar sensing session with another radar-equipped UE (e.g., the second UE 120-2).

As shown in FIG. 6A, and by reference number 605, the first UE 120-1 may transmit a discovery message. The first UE 120-1 may transmit the discovery message to discover another UE with which to establish a cooperative radar sensing session. For example, the discovery message may be a V2X (e.g., CV2X) message that signals, to one or more other UEs that receive the discovery message, the intent of the first UE 120-1 to establish a cooperative radar sensing session. In some aspects, the first UE 120-1 may periodically transmit the discovery message. For example, the first UE 120-1 may transmit the discovery message periodically, with a configured or pre-configured period, when the first UE 120-1 is not currently engaged in a cooperative sensing session. In this case, the period may be configured/pre-configured by an original equipment manufacturer (OEM), by a base station (e.g., base station 110), by user input, or specified by a wireless communication standard, among other examples.

In some aspects, the transmission of the discovery message, by the first UE 120-1, may be event-triggered. For example, the first UE 120-1 may transmit the discovery message based at least in part on receiving a basic safety message (BSM) from another UE (e.g., the second UE 120-2). The BSM may indicate the position, heading, speed, and other information for another UE (e.g., the second UE 120-2). In some aspects, the first UE 120-1 may transmit the discovery message in connection with receiving a BSM that indicates that there is another UE (e.g., the second UE 120-2) in a favorable position to perform cooperative radar sensing. For example, the first UE 120-1 may transmit the discovery message in connection with a determination that the position of the other UE (e.g., the second UE 120-2) is within a threshold distance of a position of the first UE 120-1. Additionally, or alternatively, the first UE 120-1 may transmit the discovery message based at least in part on the heading, the speed, and/or the other information included in the BSM.

In some aspects, the first UE 120-1 may broadcast the discovery message. For example, the first UE 120-1 may transmit the discovery message in a broadcast sidelink (e.g., V2X/CV2X) communication that may be received by any UE in a coverage range of the first UE 120-1. In this case, by broadcasting the discovery message, the first UE 120-1 may receive a response from any UE in the vicinity of the first UE 120-1. In some aspects, the first UE 120-1 may periodically broadcast the discovery message. In some aspects, the first UE 120-1 may broadcast the discovery message based at least in part on receiving a BSM from another UE.

In some aspects, the first UE 120-1 may groupcast the discovery message. For example, the first UE 120-1 may transmit the discovery message in a groupcast sidelink (e.g., V2X/CV2X) communication (e.g., groupcast option 1) associated with an indicated NACK distance. The first UE 120-1 may transmit the groupcast sidelink communication to a group of UEs (e.g., including the second UE 120-2), and the NACK distance may be indicated in SCI. The NACK distance specifies a distance, from the first UE 120-1, within which a UE is to return a NACK transmission if that UE cannot successfully decode the groupcast communication. This may enhance the reliability of decoding the discovery message within the NACK distance. A UE (in the group of UEs) within the NACK distance may attempt to decode the groupcast communication, and a UE (in the group of UEs) not within the NACK distance may ignore the groupcast communication. By transmitting the discovery message in the groupcast sidelink communication associated with the NACK distance, the first UE 120-1 may indicate interest in establishing a cooperative radar sensing session with another UE within the NACK distance with respect to the first UE 120-1. In some aspects, the NACK distance may be selected to enhance the likelihood of a beneficial cooperative radar sensing session with another UE that responds to the discovery message. For example, the NACK distance may indicate a distance threshold, within which there is a high likelihood of a beneficial cooperative radar sensing session between two UEs. In this case, the larger the relative distance between two UEs, the lesser the likelihood of the UEs engaging in a cooperative sensing session. In some aspects, the first UE 120-1 may periodically groupcast the discovery message. In some aspects, the first UE 120-1 may groupcast the discovery message based at least in part on receiving a BSM from another UE.

In some aspects, the first UE 120-1 may unicast the discovery message to another UE (e.g., the second UE 120-2). For example, the first UE 120-1 may transmit the discovery message in a unicast sidelink (e.g., V2X/CV2X) communication to the second UE 120-2. The second UE 120-2 may transmit a BSM that indicates a position, heading, speed, and/or other information for the second UE 120-2, and the first UE 120-1 may receive the BSM transmitted by the second UE 120-2. In some aspects, the first UE 120-1 may transmit the discovery message in the unicast sidelink communication to the second UE 120-2 based at least in part on receiving the BSM from the second UE 120-2. For example, the first UE 120-1 may transmit the discovery message in the unicast sidelink communication to the second UE 120-2 in connection with a determination, based at least in part on the information (e.g., the position, heading, speed, and/or other information) in the BSM, that the second UE 120-2 is a potential cooperator for a cooperative radar sensing session. In this case, the discovery message may be a message that indicates the interest of the first UE 120-1 in establishing a cooperative radar sensing session with the second UE 120-2.

In some aspects, the discovery message may include an indication of radar capabilities of the first UE 120-1. In some aspects, the radar capabilities indicated in the discovery message may include a respective range of supported values (for the first UE 120-1) for each of one or more radar parameters, such as bandwidth, chirp slope, and/or other radar parameters. In some aspects, the indication of the radar capabilities may include a bitmap that indicates a set of supported radar configurations from one or more codebooks. In this case, the first UE 120-1 and the second UE 120-2 (and/or one or more other UEs) may each be configured or pre-configured with a set of codebooks that indicate various radar configurations (e.g., different configurations for radar parameters). The discovery message may include a bitmap that indicates (codebook ID, codeword ID) pairs, where the codebook ID identifies a codebook in the configured/pre-configured set of codebooks and the codeword ID identifies a supported radar configuration in the codebook. In some aspects, the indication of the radar capabilities included in the discovery message may include an indication of hardware specifications of the radar sensor of the first UE 120-1, such as an oscillator stability and/or a clock stability (e.g., in parts per million (ppm)).

In some aspects, the discovery message may include a location/position of the first UE 120-1, an orientation of the first UE 120-1, and/or a trajectory of the first UE 120-1. Additionally, or alternatively, the discovery message may include a speed of the first UE 120-1, an acceleration of the first UE 120-1, and/or other information relating to the first UE 120-1.

The second UE 120-2 may receive the discovery message transmitted by the first UE 120-1. In some aspects, the second UE 120-2 may receive the discovery message in a broadcast sidelink (e.g., V2X/CV2X) communication transmitted by the first UE 120-1. In some aspects, the second UE 120-2 may receive the discovery message in a sidelink groupcast communication (e.g., an option 1 groupcast with an indicated NACK distance) transmitted by the first UE 120-1. In some aspects, the second UE 120-2 may receive the discovery message in a unicast sidelink communication transmitted from the first UE 120-1 to the second UE 120-2.

As further shown in FIG. 6A, and by reference number 610, the second UE 120-2 may transmit, to the first UE 120-1, a join request. The second UE 120-2, in connection with receiving the discovery message from the first UE 120-1, may determine whether to be a potential cooperator with the first UE 120-1 based at least in part on the information included in the discovery message. In some aspects, the second UE 120-2 may determine whether to be a potential cooperator with the first UE 120-1 based at least in part on an overlapping field of view for radar sensing between the first UE 120-1 and the second UE 120-2, relative locations of the first UE 120-1 and the second UE 120-2, and/or relative orientations of the first UE 120-1 and the second UE 120-2. For example, based at least in part on the location, orientation, and/or trajectory information in the discovery message, the second UE 120-2 may determine a size of the overlapping field of view and/or a time period for which there will be an overlapping field of view. In some aspects, the second UE 120-2 may determine whether to be a potential cooperator with the second UE 120-2 based at least in part on a determination of whether common radar parameter configurations exist that are supported by both the first UE 120-1 and the second UE 120-2. In some aspects, the second UE 120-2 may determine whether to be a potential cooperator with the first UE 120-1 based at least in part on a determination of whether the hardware specifications (e.g., the oscillator stability and/or the clock stability) of the first UE 120-1 are favorable. For example, the second UE 120-2 may determine whether the clock stability (e.g., in ppm) and/or the oscillator stability of the radar sensor of the first UE 120-1 satisfies a threshold.

The second UE 120-2 may transmit the join request to the first UE 120-1 in connection with the determination to be a potential cooperator with the first UE 120-1. The join request may identify the second UE 120-2 as a potential cooperator with the first UE 120-1 and request the first UE 120-1 to establish a cooperative radar sensing session with the second UE 120-2. The second UE 120-2 may establish a unicast link with the first UE 120-1, and the second UE 120-2 may transmit the join request in a unicast sidelink communication via the unicast link. The first UE 120-1 may receive the join request transmitted by the second UE 120-2.

In some aspects, the join request may include similar information for the second UE 120-2 that the discovery message includes for the first UE 120-1. In some aspects, the join message may include an indication of radar capabilities of the second UE 120-2. In some aspects, the radar capabilities indicated in the join request may include a respective range of supported values (for the second UE 120-2) for each of one or more radar parameters, such as bandwidth, chirp slope, and/or other radar parameters. In some aspects, the indication of the radar capabilities in the join request may include a bitmap that indicates a set of supported radar configurations from one or more configured/pre-configured codebooks. For example, the join request may include a bitmap that indicates (codebook ID, codeword ID) pairs, where the codebook ID identifies a codebook in a configured/pre-configured set of codebooks and the codeword ID identifies a supported radar configuration in the codebook. In some aspects, the indication of the radar capabilities included in the join request may include an indication of hardware specifications of the radar sensor of the second UE 120-2, such as an oscillator stability and/or a clock stability (e.g., in ppm).

In some aspects, the join request may include a location/position of the second UE 120-2, an orientation of the second UE 120-2, and/or a trajectory of the second UE 120-2. Additionally, or alternatively, the discovery message may include a speed of the second UE 120-2, an acceleration of the second UE 120-2, and/or other information relating to the second UE 120-2.

As further shown in FIG. 6A, and by reference number 615, the first UE 120-1 may transmit, to the second UE 120-2, an acceptance indication based at least in part on the join request. In some aspects, the first UE 120-1, in connection with receiving the join request from the second UE 120-2, may determine whether to accept the joint request or to reject the join request. In some aspects, the first UE 120-1 may receive respective join requests from the second UE 120-2 and from one or more other UEs, and the first UE 120-1 may determine which of the join requests to accept.

In some aspects, the first UE 120-1 may determine whether to accept or reject the join request based at least in part on a determination of whether the first UE 120-1 is already engaged in a cooperative radar sensing session with another UE (e.g., the first UE 120-1 has already accepted another join request). For example, the first UE 120-1 may reject a join request in a case in which the first UE 120-1 is already engaged in a cooperative radar sensing session with another UE. In some aspects, the first UE 120-1 may determine whether to accept or reject the join request based at least in part on the trajectories of the first UE 120-1 and the second UE 120-2 (e.g., as indicated in the join request) and/or based at least in part on the hardware specifications (e.g., oscillator stability and/or clock stability) of the second UE 120-2 (e.g., as indicated in the join request). For example, the first UE 120-1 may determine to reject the join request based at least in part on a determination, from the trajectories of the first UE 120-1 and the second UE 120-2, that a time duration for which the first UE 120-1 and the second UE 120-2 will have an overlapping sensing field of view does not satisfy a threshold. Additionally, or alternatively, the first UE 120-1 may determine to reject the join request based at least in part on a determination that the hardware specifications (e.g., oscillator stability and/or clock stability) of the second UE 120-2 are not favorable for cooperative radar sensing with the first UE 120-1. For example, the first UE 120-1 may determine to reject the join request based at least in part on a determination that the clock stability and/or the oscillator stability does not satisfy a threshold. In some aspects, the first UE 120-1 may determine to accept the join request based at least in part on a determination, from the trajectories of the first UE 120-1 and the second UE 120-2, that the time duration for which the first UE 120-1 and the second UE 120-2 will have an overlapping sensing field of view satisfies a threshold, and/or based at least in part on a determination that the clock stability and/or the oscillator stability of the second UE 120-2 satisfies a threshold.

In some aspects, in a case in which the first UE 120-1 determines to reject the join request from the second UE 120-2, the first UE 120-1 may transmit, to the second UE 120-2, a message (e.g., a unicast message) that indicates the rejection of the join request. In some aspects, as shown in FIG. 6A, in a case in which the first UE 120-1 determines to accept the join request from the second UE 120-2, the first UE 120-1 may transmit the acceptance indication to the second UE 120-2. For example, the first UE 120-1 may transmit the acceptance indication in a unicast sidelink communication to second UE 120-2. The acceptance indication indicates acceptance of the request for the first UE 120-1 to establish the cooperative radar sensing session with the second UE 120-2. The second UE 120-2 may receive the acceptance indication transmitted by the first UE 120-1.

As further shown in FIG. 6A, and by reference number 620, the first UE 120-1 and the second UE 120-2 may communicate to determine a joint configuration agreement. The joint configuration agreement may include an agreement to a common/joint radar configuration to be used by the first UE 120-1 and the second UE 120-2 for transmitting radar signals during the cooperative radar sensing session. In some aspects, the joint configuration agreement may also include an agreement to a duration of a measurement phase that occurs prior to the radar sensing in the cooperative radar sensing session. In some aspects, the joint configuration agreement may also include an agreement to a transmission ordering for multiplexing radar signal transmissions by the first UE 120-1 and the second UE 120-2 in the cooperative radar sensing session. The transmission ordering indicates an order for the radar signal transmissions by the first UE 120-1 and the second UE 120-2 in the cooperative radar sensing session.

In some aspects, the first UE 120-1 may transmit, to the second UE 120-2 (e.g., in a unicast sidelink communication), an indication of a proposed joint configuration. For example, the proposed joint configuration may include an indication of a proposed joint radar configuration to be used in the cooperative radar sensing session, an indication of a proposed duration of the measurement phase associated with the cooperative radar sensing session, and/or an indication of a proposed transmission ordering for the radar signal transmissions in the cooperative radar sensing session. In some aspects, once the first UE 120-1 transmits the acceptance indication to the second UE 120-2, the first UE 120-1 may transmit the indication of the proposed joint configuration in a separate unicast sidelink communication to the second UE 120-2. In some aspects, the first UE 120-1 may transmit the indication of the proposed joint configuration in the same unicast sidelink communication as the acceptance indication. This may provide a benefit of reducing the number of messages communicated in the discovery phase, but may also increase the payload size of the acceptance indication.

In some aspects, the second UE 120-2 may receive the indication of the proposed joint configuration, and the second UE 120-2 may determine whether to accept or reject the proposed joint configuration. In some aspects, in connection with a determination to accept the proposed joint configuration, the second UE 120-2 may transmit, to the first UE 120-1, an ACK that indicates acceptance of the proposed joint configuration by the second UE 120-2. In this case, the first UE 120-1 may receive the ACK, and the first UE 120-1 and the second UE 120-2 may proceed to the measurement phase associated with the cooperative radar sensing session.

In some aspects, the first UE 120-1 may determine to reject the proposed joint configuration. In some aspects, in connection with the determination to reject the proposed joint configuration, the second UE 120-2 may transmit, to the first UE 120-1, a rejection of the proposed joint configuration, and the cooperative radar sensing session between the first UE 120-1 and the second UE 120-2 may be canceled. In some aspects, in connection with the determination to reject the proposed joint configuration, the second UE 120-2 may transmit, to the first UE 120-1 a counter proposal for the proposed joint configuration. For example, the second UE 120-2 may receive an indication of a first proposed joint configuration from the first UE 120-1, and the second UE 120-2 may transmit, to the first UE 120-1, a rejection of the first proposed joint configuration and an indication of a second proposed joint configuration. In this case, the second proposed joint configuration may indicate a different proposed joint radar configuration, a different proposed duration of the measurement phase, and/or a different proposed transmission ordering from the first proposed joint configuration. The first UE 120-1 may receive the second proposed joint configuration, and the first UE 120-1 may determine whether to accept or reject the second proposed joint configuration. For example, in connection with a determination to accept the second proposed joint configuration, the first UE 120-1 may transmit, to the second UE 120-2 an ACK indicating acceptance of the second proposed joint configuration. In some aspects, in connection with a determination to reject the second proposed joint configuration, the first UE 120-1 may transmit a counter proposal (e.g., an indication of a third proposed joint configuration) to the second UE 120-2. In this case, the first UE 120-1 and the second UE 120-2 may continue with such “handshaking” communications with proposed joint configurations until an agreement on the joint configuration is reached or maximum number of rounds is reached. In a case in which the maximum number of rounds is reached with no agreement, the communications between the first UE 120-1 and the second UE 120-2 may be terminated and the cooperative radar sensing session may be canceled.

In some aspects, the second UE 120-2 may transmit the first proposed joint configuration to the first UE 120-1. In some aspects, the second UE 120-2 may include the first proposed joint configuration in the join request transmitted to the first UE 120-1 in connection with receiving the discover message from the first UE 120-1. This may provide a benefit of reducing the number of messages communicated in the discovery phase, but may also increase the payload size of the join request. In this case, the first UE 120-1, based at least in part on receiving the join request, may determine whether to accept or reject the join request and whether to accept or reject the first proposed joint configuration. In some aspects, in connection with a determination to accept the join request and a determination to accept the first proposed joint configuration, the first UE 120-1 may transmit, to the second UE 120-2, the acceptance indication. In this case, the acceptance indication may include an ACK that indicates acceptance of the join request and acceptance of the first proposed joint indication. In some aspects, the first UE 120-1 may transmit, to the second UE 120-2, a counter proposal (e.g., a second proposed joint configuration) to the first proposed joint configuration. In this case, the second UE 120-2 may determine whether to accept or reject the counter proposal, and the first UE 120-1 and the second UE 120-2 may continue with the “handshaking” communications until an agreement on the joint configuration is reached or a maximum number of rounds is reached.

As shown in FIG. 6B, and by reference number 625, once the first UE 120-1 and the second UE 120-2 establish the joint configuration agreement, the first UE 120-1 and the second UE 120-2 may proceed to the measurement phase associated with the cooperative radar sensing session. In the measurement phase, which precedes the cooperative radar sensing session, the first UE 120-1 and/or the second UE 120-2 may perform measurements to determine if bistatic reception of radar signals transmitted from the other UE is reliable. In some aspects, the first UE 120-1 may perform measurements on reflections, received at the first UE 120-1, of radar signals transmitted by the second UE 120-2. Additionally, or alternatively, the second UE 120-2 may perform measurements on reflections, received by the second UE 120-2, of radar signals transmitted by the first UE 120-1. The duration of the measurement phase may be indicated in the joint configuration agreed to by the first UE 120-1 and the second UE 120-2.

As further shown in FIG. 6B, and by reference number 630, the first UE 120-1 and the second UE 120-2 may perform cooperative radar sensing during the cooperative radar sensing session. The first UE 120-1 may transmit first radar signals 635 during the cooperative radar sensing session, and the second UE 120-2 may transmit second radar signals 640 during the cooperative radar sensing session. In some aspects, the first UE 120-1 may transmit the first radar signals 635 using the joint radar configuration, and the second UE 120-2 may transmit the second radar signals 640 using the joint radar configuration. In this way, the first radar signals 635 and the second radar signals 640 may be transmitted with the same radar waveform (e.g., the same bandwidth, chirp slope, and chirp duration), such that the first UE 120-1 and/or the second UE 120-2 may process both monostatic reflections and bistatic reflections during the cooperative radar sensing session. Transmissions of the first radar signals 635, by the first UE 120-1, and transmissions of the second radar signals 640, by the second UE 120-2, may be multiplexed according to the transmission ordering indicated in the joint configuration agreement. For example, the first UE 120-1 and the second UE 120-2 may alternate transmissions of the first radar signals 635 and the second radar signals 640, respectively, according to the transmission ordering indicated in the joint configuration agreement, resulting in time division multiplexing of the first radar signals 635 and the second radar signals 640 in the cooperative radar sensing session.

As shown in FIG. 6B, during the cooperative radar sensing session, the first UE 120-1 may perform radar sensing using first radar reflected signals (e.g., reflections of the first radar signals 635) transmitted by the first UE 120-1 and second reflected radar signals (e.g., reflections of the second radar signals 640) transmitted by the second UE 120-2. For example, the first UE 120-1 may receive monostatic reflections of the first radar signals 635 that are reflected by a target object and bistatic reflections of the second radar signals 640 that are reflected by the target object. The first UE 120-1 may generate a point cloud representing a location and a shape of the target object using both the monostatic returns (e.g., the reflections of the first radar signals 635) and the bistatic returns (e.g., the reflections of the second radar signals 640).

In some aspects, during the cooperative radar sensing session, the second UE 120-2 may also perform radar sensing using reflected radar signals transmitted by the second UE 120-2 (e.g., reflections of the second radar signals 640) and reflected radar signals transmitted by the first UE 120-1 (e.g., reflections of the first radar signals). For example, the second UE 120-2 may receive monostatic reflections of the second radar signals 640 that are reflected by a target object and bistatic reflections of the first radar signals 635 that are reflected by the target object. The second UE 120-2 may generate a point cloud representing a location and a shape of the target object using both the monostatic returns (e.g., the reflections of the second radar signals 640) and the bistatic returns (e.g., the reflections of the first radar signals 635).

As described above, the first UE 120-1 may transmit a discovery message to discover another UE with which to establish a cooperative radar sensing session. The second UE 120-2 may receive the discovery message, and the second UE 120-2 may transmit, to the first UE 120-1, a join request for the first UE 120-1 to establish the cooperative radar sensing session with the second UE 120-2. The first UE 120-1 may receive the join request, and the first UE 120-1 may transmit, to the second UE 120-2, an acceptance indication based at least in part on the join request. The first UE 120-1 and the second UE 120-2 may communicate to establish a joint configuration to be used by the first UE 120-1 and the second UE 120-2 for the cooperative radar sensing session.

In accordance with the above description, a UE may be able to discover and establish a cooperative radar sensing session with another UE. In addition, the UEs may agree to a joint configuration for radar sensing, which may result in the UEs being able to process both monostatic and bistatic returns during the cooperative radar sensing session. This may allow the UEs to improve the performance of radar sensing, as compared to stand-alone radar sensing using the monostatic returns, and reduce interference due to radar sensing by nearby UEs.

As indicated above, FIGS. 6A-6B are provided as an example. Other examples may differ from what is described with respect to FIGS. 6A-6B.

FIG. 7 is a diagram illustrating an example process 700 performed, for example, by a first UE, in accordance with the present disclosure. Example process 700 is an example where the UE (e.g., UE 120) performs operations associated with establishing cooperative radar sensing sessions.

As shown in FIG. 7, in some aspects, process 700 may include transmitting a discovery message to discover another UE with which to establish a cooperative radar sensing session (block 710). For example, the first UE (e.g., using communication manager 140 and/or transmission component 904, depicted in FIG. 900) may transmit a discovery message to discover another UE with which to establish a cooperative radar sensing session, as described above.

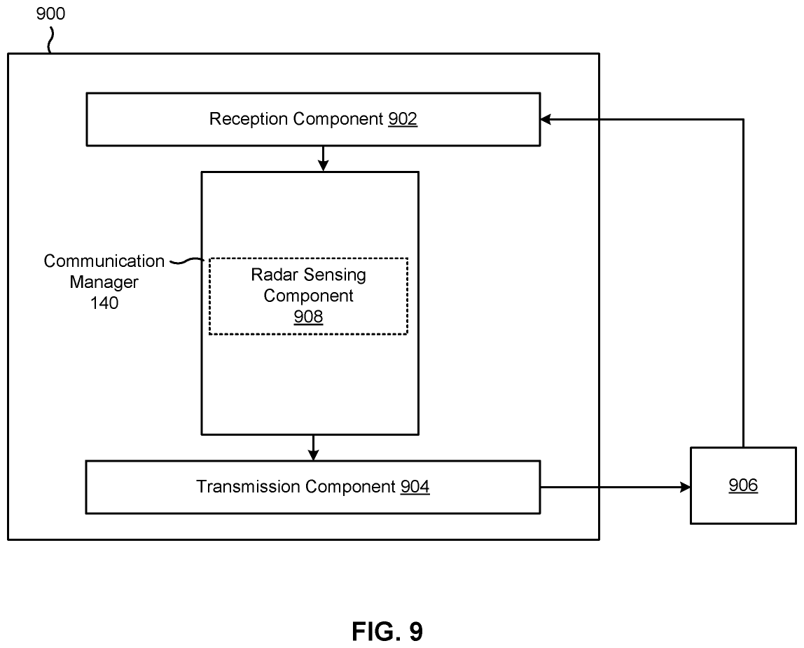

As further shown in FIG. 7, in some aspects, process 700 may include receiving, from a second UE, a join request for the first UE to establish the cooperative radar sensing session with the second UE (block 720). For example, the first UE (e.g., using communication manager 140 and/or reception component 902, depicted in FIG. 9) may receive, from a second UE, a join request for the first UE to establish the cooperative radar sensing session with the second UE, as described above.

As further shown in FIG. 7, in some aspects, process 700 may include transmitting, to the second UE, an acceptance indication based at least in part on the join request (block 730). For example, the first UE (e.g., using communication manager 140 and/or transmission component 904, depicted in FIG. 9) may transmit, to the second UE, an acceptance indication based at least in part on the join request, as described above.

As further shown in FIG. 7, in some aspects, process 700 may include communicating with the second UE to establish a joint configuration to be used by the first UE and the second UE for the cooperative radar sensing session (block 740). For example, the first UE (e.g., using communication manager 140, reception component 902, and/or transmission component 904, depicted in FIG. 9) may communicate with the second UE to establish a joint configuration to be used by the first UE and the second UE for the cooperative radar sensing session, as described above.

Process 700 may include additional aspects, such as any single aspect or any combination of aspects described below and/or in connection with one or more other processes described elsewhere herein.

In a first aspect, transmitting the discovery message includes periodically transmitting the discovery message.

In a second aspect, alone or in combination with the first aspect, process 700 includes receiving, from the second UE, a basic safety message, and transmitting the discovery message includes transmitting the discovery message based at least in part on receiving the basic safety message from the second UE.

In a third aspect, alone or in combination with one or more of the first and second aspects, transmitting the discovery message based at least in part on receiving the basic safety message from the second UE includes transmitting the discovery message in a unicast sidelink communication to the second UE based at least in part on receiving the basic safety message from the second UE.

In a fourth aspect, alone or in combination with one or more of the first through third aspects, transmitting the discovery message includes transmitting the discovery message in a broadcast sidelink communication.

In a fifth aspect, alone or in combination with one or more of the first through fourth aspects, transmitting the discovery message includes transmitting the discovery message in a groupcast sidelink communication associated with an indicated NACK distance.

In a sixth aspect, alone or in combination with one or more of the first through fifth aspects, the discovery message includes an indication of radar capabilities of the first UE.

In a seventh aspect, alone or in combination with one or more of the first through sixth aspects, the indication of radar capabilities of the first UE includes an indication of a respective range of supported values for each of one or more radar parameters.

In an eighth aspect, alone or in combination with one or more of the first through seventh aspects, the one or more radar parameters include at least one of a bandwidth and a chirp slope.

In a ninth aspect, alone or in combination with one or more of the first through eighth aspects, the indication of radar capabilities of the first UE includes a bitmap that indicates a set of supported radar configurations from one or more codebooks.

In a tenth aspect, alone or in combination with one or more of the first through ninth aspects, the indication of radar capabilities of the first UE includes an indication of at least one of an oscillator stability or a clock stability for the first UE.

In an eleventh aspect, alone or in combination with one or more of the first through tenth aspects, the discovery message includes an indication of at least one of a location of the first UE, an orientation of the first UE, or a trajectory of the first UE.

In a twelfth aspect, alone or in combination with one or more of the first through eleventh aspects, the join request includes an indication of at least one of radar capabilities of the second UE, a location of the second UE, an orientation of the second UE, or a trajectory of the second UE.

In a thirteenth aspect, alone or in combination with one or more of the first through twelfth aspects, transmitting the acceptance indication includes transmitting the acceptance indication in connection with a determination to establish the cooperative radar sensing session with the second UE based at least in part on information included in the join request.

In a fourteenth aspect, alone or in combination with one or more of the first through thirteenth aspects, the joint configuration includes at least one of a joint radar configuration to be used by the first UE and the second UE in the cooperative radar sensing session, a duration of a measurement phase associated with the cooperative radar sensing session, or an order for radar signal transmissions by the first UE and the second UE in the cooperative radar sensing session.

In a fifteenth aspect, alone or in combination with one or more of the first through fourteenth aspects, communicating with the second UE to establish the joint configuration includes transmitting, to the second UE, an indication of a proposed joint configuration, and receiving, from the second UE, an acknowledgement that indicates acceptance of the proposed joint configuration by the second UE.

In a sixteenth aspect, alone or in combination with one or more of the first through fifteenth aspects, communicating with the second UE to establish the joint configuration includes transmitting, to the second UE, an indication of a first proposed joint configuration, receiving, from the second UE, a rejection of the first proposed joint configuration and an indication of a second proposed joint configuration, and transmitting, to the second UE, an acknowledgement indicating acceptance of the second proposed joint configuration.

In a seventeenth aspect, alone or in combination with one or more of the first through sixteenth aspects, communication with the second UE to establish the joint configuration includes receiving, from the second UE, an indication of a first proposed joint configuration, and transmitting, to the second UE, an acknowledgement indicating acceptance of the first proposed joint configuration or an indication of a second proposed joint configuration.

In an eighteenth aspect, alone or in combination with one or more of the first through seventeenth aspects, the indication of the first proposed joint configuration is included in the join request.

In a nineteenth aspect, alone or in combination with one or more of the first through eighteenth aspects, process 700 includes performing radar sensing, during the cooperative radar sensing session, using first reflected radar signals transmitted by the first UE and second reflected radar signals transmitted by the second UE.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a second UE, in accordance with the present disclosure. Example process 800 is an example where the UE (e.g., UE 120) performs operations associated with establishing cooperative radar sensing sessions.

As shown in FIG. 8, in some aspects, process 800 may include receiving, from a first UE, a discovery message relating to establishing a cooperative radar sensing session (block 810). For example, the second UE (e.g., using communication manager 140 and/or reception component 902, depicted in FIG. 9) may receive, from a first UE, a discovery message relating to establishing a cooperative radar sensing session, as described above.

As further shown in FIG. 8, in some aspects, process 800 may include transmitting, to the first UE, a join request for the first UE to establish the cooperative radar sensing session with the second UE (block 820). For example, the second UE (e.g., using communication manager 140 and/or transmission component 904, depicted in FIG. 9) may transmit, to the first UE, a join request for the first UE to establish the cooperative radar sensing session with the second UE, as described above.

As further shown in FIG. 8, in some aspects, process 800 may include receiving, from the first UE, an acceptance indication based at least in part on the join request (block 830). For example, the second UE (e.g., using communication manager 140 and/or reception component 902, depicted in FIG. 9) may receive, from the first UE, an acceptance indication based at least in part on the join request, as described above.

As further shown in FIG. 8, in some aspects, process 800 may include communicating with the first UE to establish a joint configuration to be used by the first UE and the second UE for the cooperative radar sensing session (block 840). For example, the second UE (e.g., using communication manager 140, reception component 902, and/or transmission component 904, depicted in FIG. 9) may communicate with the first UE to establish a joint configuration to be used by the first UE and the second UE for the cooperative radar sensing session, as described above.

Process 800 may include additional aspects, such as any single aspect or any combination of aspects described below and/or in connection with one or more other processes described elsewhere herein.

In a first aspect, receiving the discovery message includes receiving the discovery message in a broadcast sidelink communication.

In a second aspect, alone or in combination with the first aspect, receiving the discovery message includes receiving the discovery message in a groupcast sidelink communication associated with an indicated NACK distance.

In a third aspect, alone or in combination with one or more of the first and second aspects, receiving the discovery message includes receiving the discovery message in a unicast sidelink communication from the first UE.

In a fourth aspect, alone or in combination with one or more of the first through third aspects, the discovery message includes an indication of radar capabilities of the first UE.

In a fifth aspect, alone or in combination with one or more of the first through fourth aspects, the indication of radar capabilities of the first UE includes an indication of a respective range of supported values for each of one or more radar parameters.

In a sixth aspect, alone or in combination with one or more of the first through fifth aspects, the one or more radar parameters include at least one of a bandwidth and a chirp slope.

In a seventh aspect, alone or in combination with one or more of the first through sixth aspects, the indication of radar capabilities of the first UE includes a bitmap that indicates a set of supported radar configurations from one or more codebooks.

In an eighth aspect, alone or in combination with one or more of the first through seventh aspects, the indication of radar capabilities of the first UE includes an indication of at least one of an oscillator stability or a clock stability for the first UE.

In a ninth aspect, alone or in combination with one or more of the first through eighth aspects, the discovery message includes an indication of at least one of a location of the first UE, an orientation of the first UE, or a trajectory of the first UE.

In a tenth aspect, alone or in combination with one or more of the first through ninth aspects, the join request includes an indication of at least one of radar capabilities of the second UE, a location of the second UE, an orientation of the second UE, or a trajectory of the second UE.

In an eleventh aspect, alone or in combination with one or more of the first through tenth aspects, the joint configuration includes at least one of a joint radar configuration to be used by the first UE and the second UE in the cooperative radar sensing session, a duration of a measurement phase associated with the cooperative radar sensing session, or an order for radar signal transmissions by the first UE and the second UE in the cooperative radar sensing session.

In a twelfth aspect, alone or in combination with one or more of the first through eleventh aspects, communicating with the first UE to establish the joint configuration includes receiving, from the first UE, an indication of a proposed joint configuration, and transmitting, to the first UE, an acknowledgement that indicates acceptance of the proposed joint configuration by the second UE.

In a thirteenth aspect, alone or in combination with one or more of the first through twelfth aspects, communicating with the first UE to establish the joint configuration includes receiving, from the first UE, an indication of a first proposed joint configuration, transmitting, to the first UE, a rejection of the first proposed joint configuration and an indication of a second proposed joint configuration, and receiving, from the first UE, an acknowledgement indicating acceptance of the second proposed joint configuration.

In a fourteenth aspect, alone or in combination with one or more of the first through thirteenth aspects, communication with the first UE to establish the joint configuration includes transmitting, to the first UE, an indication of a first proposed joint configuration, and receiving, from the first UE, an acknowledgement indicating acceptance of the first proposed joint configuration or an indication of a second proposed joint configuration.

In a fifteenth aspect, alone or in combination with one or more of the first through fourteenth aspects, the indication of the first proposed joint configuration is included in the join request.

In a sixteenth aspect, alone or in combination with one or more of the first through fifteenth aspects, process 800 includes performing radar sensing, during the cooperative radar sensing session, using first reflected radar signals transmitted by the first UE and second reflected radar signals transmitted by the second UE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include a radar sensing component 908.

In some aspects, the apparatus 900 may be configured to perform one or more operations described herein in connection with FIGS. 6A-6B. Additionally, or alternatively, the apparatus 900 may be configured to perform one or more processes described herein, such as process 700 of FIG. 7, process 800 of FIG. 8, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The transmission component 904 may transmit a discovery message to discover another UE with which to establish a cooperative radar sensing session. The reception component 902 may receive, from a second UE, a join request for the UE to establish the cooperative radar sensing session with the second UE. The transmission component 904 may transmit, to the second UE, an acceptance indication based at least in part on the join request. The reception component 902 and/or the transmission component 904 may communicate with the second UE to establish a joint configuration to be used by the UE and the second UE for the cooperative radar sensing session.

The reception component 902 may receive, from the second UE, a basic safety message, wherein transmitting the discovery message comprises transmitting the discovery message based at least in part on receiving the basic safety message from the second UE.

The radar sensing component 908 may perform radar sensing, during the cooperative radar sensing session, using first reflected radar signals transmitted by the UE and second reflected radar signals transmitted by the second UE.

The reception component 902 may receive, from a first UE, a discovery message relating to establishing a cooperative radar sensing session. The transmission component 904 may transmit, to the first UE, a join request for the first UE to establish the cooperative radar sensing session with the UE. The reception component 902 may receive, from the first UE, an acceptance indication based at least in part on the join request. The reception component 902 and/or the transmission component 904 may communicate with the first UE to establish a joint configuration to be used by the first UE and the UE for the cooperative radar sensing session.

The radar sensing component 908 may perform radar sensing, during the cooperative radar sensing session, using first reflected radar signals transmitted by the first UE and second reflected radar signals transmitted by the UE.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a first user equipment (UE), comprising: transmitting a discovery message to discover another UE with which to establish a cooperative radar sensing session; receiving, from a second UE, a join request for the first UE to establish the cooperative radar sensing session with the second UE; transmitting, to the second UE, an acceptance indication based at least in part on the join request; and communicating with the second UE to establish a joint configuration to be used by the first UE and the second UE for the cooperative radar sensing session.

Aspect 2: The method of Aspect 1, wherein transmitting the discovery message comprises: periodically transmitting the discovery message.

Aspect 3: The method of Aspect 1, further comprising: receiving, from the second UE, a basic safety message, wherein transmitting the discovery message comprises transmitting the discovery message based at least in part on receiving the basic safety message from the second UE.

Aspect 4: The method of Aspect 3, wherein transmitting the discovery message based at least in part on receiving the basic safety message from the second UE comprises: transmitting the discovery message in a unicast sidelink communication to the second UE based at least in part on receiving the basic safety message from the second UE.

Aspect 5: The method of any of Aspects 1-3, wherein transmitting the discovery message comprises: transmitting the discovery message in a broadcast sidelink communication.

Aspect 6: The method of any of Aspects 1-3, wherein transmitting the discovery message comprises: transmitting the discovery message in a groupcast sidelink communication associated with an indicated negative acknowledgement (NACK) distance.

Aspect 7: The method of any of Aspects 1-6, wherein the discovery message includes an indication of radar capabilities of the first UE.

Aspect 8: The method of Aspect 7, wherein the indication of radar capabilities of the first UE includes an indication of a respective range of supported values for each of one or more radar parameters.

Aspect 9: The method of Aspect 8, wherein the one or more radar parameters include at least one of a bandwidth and a chirp slope.

Aspect 10: The method of any of Aspects 7-9, wherein the indication of radar capabilities of the first UE includes a bitmap that indicates a set of supported radar configurations from one or more codebooks.

Aspect 11: The method of any of Aspects 7-10, wherein the indication of radar capabilities of the first UE includes an indication of at least one of an oscillator stability or a clock stability for the first UE.

Aspect 12: The method of any of Aspects 1-11, wherein the discovery message includes an indication of at least one of a location of the first UE, an orientation of the first UE, or a trajectory of the first UE.

Aspect 13: The method of any of Aspects 1-12, wherein the join request includes an indication of at least one of radar capabilities of the second UE, a location of the second UE, an orientation of the second UE, or a trajectory of the second UE.

Aspect 14: The method of Aspect 13, wherein transmitting the acceptance indication comprises: transmitting the acceptance indication in connection with a determination to establish the cooperative radar sensing session with the second UE based at least in part on information included in the join request.

Aspect 15: The method of any of Aspects 1-14, wherein the joint configuration includes at least one of a joint radar configuration to be used by the first UE and the second UE in the cooperative radar sensing session, a duration of a measurement phase associated with the cooperative radar sensing session, or an order for radar signal transmissions by the first UE and the second UE in the cooperative radar sensing session.

Aspect 16: The method of any of Aspects 1-15, wherein communicating with the second UE to establish the joint configuration comprises: transmitting, to the second UE, an indication of a proposed joint configuration; and receiving, from the second UE, an acknowledgement that indicates acceptance of the proposed joint configuration by the second UE.

Aspect 17: The method of any of Aspects 1-15, wherein communicating with the second UE to establish the joint configuration comprises: transmitting, to the second UE, an indication of a first proposed joint configuration; receiving, from the second UE, a rejection of the first proposed joint configuration and an indication of a second proposed joint configuration; and transmitting, to the second UE, an acknowledgement indicating acceptance of the second proposed joint configuration.

Aspect 18: The method of any of Aspects 1-15, wherein communication with the second UE to establish the joint configuration comprises: receiving, from the second UE, an indication of a first proposed joint configuration; and transmitting, to the second UE, an acknowledgement indicating acceptance of the first proposed joint configuration or an indication of a second proposed joint configuration.

Aspect 19: The method of Aspect 18, wherein the indication of the first proposed joint configuration is included in the join request.

Aspect 20: The method of any of Aspects 1-19, further comprising: performing radar sensing, during the cooperative radar sensing session, using first reflected radar signals transmitted by the first UE and second reflected radar signals transmitted by the second UE.

Aspect 21: A method of wireless communication performed by a second user equipment (UE), comprising: receiving, from a first UE, a discovery message relating to establishing a cooperative radar sensing session; transmitting, to the first UE, a join request for the first UE to establish the cooperative radar sensing session with the second UE; receiving, from the first UE, an acceptance indication based at least in part on the join request; and communicating with the first UE to establish a joint configuration to be used by the first UE and the second UE for the cooperative radar sensing session.

Aspect 22: The method of Aspect 21, wherein receiving the discovery message comprises: receiving the discovery message in a broadcast sidelink communication.

Aspect 23: The method of Aspect 21, wherein receiving the discovery message comprises: receiving the discovery message in a groupcast sidelink communication associated with an indicated negative acknowledgement (NACK) distance.

Aspect 24: The method of Aspect 21, wherein receiving the discovery message comprises: receiving the discovery message in a unicast sidelink communication from the first UE.

Aspect 25: The method of any of Aspects 21-24, wherein the discovery message includes an indication of radar capabilities of the first UE.

Aspect 26: The method of Aspect 25, wherein the indication of radar capabilities of the first UE includes an indication of a respective range of supported values for each of one or more radar parameters.

Aspect 27: The method of Aspect 26, wherein the one or more radar parameters include at least one of a bandwidth and a chirp slope.

Aspect 28: The method of any of Aspects 25-27, wherein the indication of radar capabilities of the first UE includes a bitmap that indicates a set of supported radar configurations from one or more codebooks.

Aspect 29: The method of any of Aspects 25-28, wherein the indication of radar capabilities of the first UE includes an indication of at least one of an oscillator stability or a clock stability for the first UE.

Aspect 30: The method of any of Aspects 21-29, wherein the discovery message includes an indication of at least one of a location of the first UE, an orientation of the first UE, or a trajectory of the first UE.

Aspect 31: The method of any of Aspects 21-30, wherein the join request includes an indication of at least one of radar capabilities of the second UE, a location of the second UE, an orientation of the second UE, or a trajectory of the second UE.

Aspect 32: The method of any of Aspects 21-31, wherein the joint configuration includes at least one of a joint radar configuration to be used by the first UE and the second UE in the cooperative radar sensing session, a duration of a measurement phase associated with the cooperative radar sensing session, or an order for radar signal transmissions by the first UE and the second UE in the cooperative radar sensing session.

Aspect 33: The method of any of Aspects 21-32, wherein communicating with the first UE to establish the joint configuration comprises: receiving, from the first UE, an indication of a proposed joint configuration; and transmitting, to the first UE, an acknowledgement that indicates acceptance of the proposed joint configuration by the second UE.

Aspect 34: The method of any of Aspects 21-32, wherein communicating with the first UE to establish the joint configuration comprises: receiving, from the first UE, an indication of a first proposed joint configuration; transmitting, to the first UE, a rejection of the first proposed joint configuration and an indication of a second proposed joint configuration; and receiving, from the first UE, an acknowledgement indicating acceptance of the second proposed joint configuration.

Aspect 35: The method of any of Aspects 21-32, wherein communication with the first UE to establish the joint configuration comprises: transmitting, to the first UE, an indication of a first proposed joint configuration; and receiving, from the first UE, an acknowledgement indicating acceptance of the first proposed joint configuration or an indication of a second proposed joint configuration.

Aspect 36: The method of Aspect 35, wherein the indication of the first proposed joint configuration is included in the join request.

Aspect 37: The method of any of Aspects 21-36, further comprising: performing radar sensing, during the cooperative radar sensing session, using first reflected radar signals transmitted by the first UE and second reflected radar signals transmitted by the second UE.

Aspect 38: An apparatus for wireless communication at a device, comprising a processor; memory coupled with the processor; and instructions stored in the memory and executable by the processor to cause the apparatus to perform the method of one or more of Aspects 1-20.

Aspect 39: A device for wireless communication, comprising a memory and one or more processors coupled to the memory, the one or more processors configured to perform the method of one or more of Aspects 1-20.

Aspect 40: An apparatus for wireless communication, comprising at least one means for performing the method of one or more of Aspects 1-20.

Aspect 41: A non-transitory computer-readable medium storing code for wireless communication, the code comprising instructions executable by a processor to perform the method of one or more of Aspects 1-20.

Aspect 42: A non-transitory computer-readable medium storing a set of instructions for wireless communication, the set of instructions comprising one or more instructions that, when executed by one or more processors of a device, cause the device to perform the method of one or more of Aspects 1-20.

Aspect 43: An apparatus for wireless communication at a device, comprising a processor; memory coupled with the processor; and instructions stored in the memory and executable by the processor to cause the apparatus to perform the method of one or more of Aspects 21-37.

Aspect 44: A device for wireless communication, comprising a memory and one or more processors coupled to the memory, the one or more processors configured to perform the method of one or more of Aspects 21-37.

Aspect 45: An apparatus for wireless communication, comprising at least one means for performing the method of one or more of Aspects 21-37.

Aspect 46: A non-transitory computer-readable medium storing code for wireless communication, the code comprising instructions executable by a processor to perform the method of one or more of Aspects 21-37.

Aspect 47: A non-transitory computer-readable medium storing a set of instructions for wireless communication, the set of instructions comprising one or more instructions that, when executed by one or more processors of a device, cause the device to perform the method of one or more of Aspects 21-37.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first user equipment (UE) for wireless communication, comprising:
a memory; and
one or more processors, coupled to the memory, configured to:
transmit a discovery message to discover another UE with which to establish a cooperative radar sensing session;
receive, from a second UE, a join request for the first UE to establish the cooperative radar sensing session with the second UE;
transmit, to the second UE, an acceptance indication based at least in part on the join request; and
communicate with the second UE to establish a joint configuration to be used by the first UE and the second UE for the cooperative radar sensing session.

2. The UE of claim 1, wherein the one or more processors, to transmit the discovery message, are configured to:
periodically transmit the discovery message.

3. The UE of claim 1, wherein the one or more processors are further configured to:
receive, from the second UE, a basic safety message, wherein transmitting the discovery message comprises transmitting the discovery message based at least in part on receiving the basic safety message from the second UE.

4. The UE of claim 3, wherein the one or more processors, to transmit the discovery message based at least in part on receiving the basic safety message from the second UE, are configured to:
transmit the discovery message in a unicast sidelink communication to the second UE based at least in part on receiving the basic safety message from the second UE.

5. The UE of claim 1, wherein the one or more processors, to transmit the discovery message, are configured to:
transmit the discovery message in a broadcast sidelink communication or in a groupcast sidelink communication associated with an indicated negative acknowledgement (NACK) distance.

6. The UE of claim 1, wherein the discovery message includes an indication of radar capabilities of the first UE.

7. The UE of claim 6, wherein the indication of radar capabilities of the first UE includes an indication of a respective range of supported values for each of one or more radar parameters, and wherein the one or more radar parameters include at least one of a bandwidth and a chirp slope.

8. The UE of claim 6, wherein the indication of radar capabilities of the first UE includes a bitmap that indicates a set of supported radar configurations from one or more codebooks.

9. The UE of claim 6, wherein the indication of radar capabilities of the first UE includes an indication of at least one of an oscillator stability or a clock stability for the first UE.

10. The UE of claim 1, wherein the discovery message includes an indication of at least one of a location of the first UE, an orientation of the first UE, or a trajectory of the first UE.

11. The UE of claim 1, wherein the join request includes an indication of at least one of radar capabilities of the second UE, a location of the second UE, an orientation of the second UE, or a trajectory of the second UE.

12. The UE of claim 1, wherein the joint configuration includes at least one of a joint radar configuration to be used by the first UE and the second UE in the cooperative radar sensing session, a duration of a measurement phase associated with the cooperative radar sensing session, or an order for radar signal transmissions by the first UE and the second UE in the cooperative radar sensing session.

13. The UE of claim 1, wherein the one or more processors, to communicate with the second UE to establish the joint configuration, are configured to:
transmit, to the second UE, an indication of a proposed joint configuration; and
receive, from the second UE, an acknowledgement that indicates acceptance of the proposed joint configuration by the second UE.

14. The UE of claim 1, wherein the one or more processors, to communicate with the second UE to establish the joint configuration, are configured to:
transmit, to the second UE, an indication of a first proposed joint configuration;
receive, from the second UE, a rejection of the first proposed joint configuration and an indication of a second proposed joint configuration; and
transmit, to the second UE, an acknowledgement indicating acceptance of the second proposed joint configuration.

15. The UE of claim 1, wherein communication with the second UE to establish the joint configuration comprises:
receive, from the second UE, an indication of a first proposed joint configuration; and
transmit, to the second UE, an acknowledgement indicating acceptance of the first proposed joint configuration or an indication of a second proposed joint configuration.

16. The UE of claim 15, wherein the indication of the first proposed joint configuration is included in the join request.

17. The UE of claim 1, wherein the one or more processors are further configured to:
perform radar sensing, during the cooperative radar sensing session, using first reflected radar signals transmitted by the first UE and second reflected radar signals transmitted by the second UE.

18. A second user equipment (UE) for wireless communication, comprising:
a memory; and
one or more processors, coupled to the memory, configured to:
receive, from a first UE, a discovery message relating to establishing a cooperative radar sensing session;
transmit, to the first UE, a join request for the first UE to establish the cooperative radar sensing session with the second UE;
receive, from the first UE, an acceptance indication based at least in part on the join request; and
communicate with the first UE to establish a joint configuration to be used by the first UE and the second UE for the cooperative radar sensing session.

19. The UE of claim 18, wherein the one or more processors, to receive the discovery message, are configured to:
receive the discovery message in a broadcast sidelink communication, in a groupcast sidelink communication associated with an indicated negative acknowledgement (NACK) distance, in a unicast sidelink communication.

20. The UE of claim 18, wherein the discovery message includes an indication of radar capabilities of the first UE, a location of the first UE, an orientation of the first UE, or a trajectory of the first UE.

21. The UE of claim 18, wherein the join request includes an indication of at least one of radar capabilities of the second UE, a location of the second UE, an orientation of the second UE, or a trajectory of the second UE.

22. The UE of claim 18, wherein the joint configuration includes at least one of a joint radar configuration to be used by the first UE and the second UE in the cooperative radar sensing session, a duration of a measurement phase associated with the cooperative radar sensing session, or an order for radar signal transmissions by the first UE and the second UE in the cooperative radar sensing session.

23. The UE of claim 18, wherein the one or more processors are further configured to:
perform radar sensing, during the cooperative radar sensing session, using first reflected radar signals transmitted by the first UE and second reflected radar signals transmitted by the second UE.

24. A method of wireless communication performed by a first user equipment (UE), comprising:
transmitting a discovery message to discover another UE with which to establish a cooperative radar sensing session;
receiving, from a second UE, a join request for the first UE to establish the cooperative radar sensing session with the second UE;
transmitting, to the second UE, an acceptance indication based at least in part on the join request; and
communicating with the second UE to establish a joint configuration to be used by the first UE and the second UE for the cooperative radar sensing session.

25. The method of claim 24, wherein transmitting the discovery message comprises:
transmitting the discovery message in a broadcast sidelink communication, in a groupcast sidelink communication associated with an indicated negative acknowledgement (NACK) distance, or in a unicast sidelink communication to the second UE.

26. The method of claim 24, wherein the discovery message includes an indication of at least one of radar capabilities of the first UE, a location of the first UE, an orientation of the first UE, or a trajectory of the first UE.

27. The method of claim 24, wherein the join request includes an indication of at least one of radar capabilities of the second UE, a location of the second UE, an orientation of the second UE, or a trajectory of the second UE.

28. The method of claim 24, wherein the joint configuration includes at least one of a joint radar configuration to be used by the first UE and the second UE in the cooperative radar sensing session, a duration of a measurement phase associated with the cooperative radar sensing session, or an order for radar signal transmissions by the first UE and the second UE in the cooperative radar sensing session.

29. The method of claim 24, further comprising:
performing radar sensing, during the cooperative radar sensing session, using first reflected radar signals transmitted by the first UE and second reflected radar signals transmitted by the second UE.

30. A method of wireless communication performed by a second user equipment (UE), comprising:
receiving, from a first UE, a discovery message relating to establishing a cooperative radar sensing session;
transmitting, to the first UE, a join request for the first UE to establish the cooperative radar sensing session with the second UE;
receiving, from the first UE, an acceptance indication based at least in part on the join request; and
communicating with the first UE to establish a joint configuration to be used by the first UE and the second UE for the cooperative radar sensing session.
